(19) United States
(12) Patent Application Publication
(10) Pub. No.: US 2004/0042172 A1
(43) Pub. Date: Mar. 4, 2004

(54) Electronic apparatus comprising heat generating element

(75) Inventors: Hiroyuki Kusaka, Ome-shi (JP); Kentaro Tomioka, Sayama-shi (JP)

Correspondence Address: Finnegan, Henderson, Farabow,, Garrett & Dunner, L.L.P., 1300 I Street, N.W., Washington, DC, 20005-3315, US

(73) Assignee: Kabushiki Kaisha Toshiba

(21) Appl. No.: 10/636,572

(22) Filed: Aug. 8, 2003

(30) Foreign Application Priority Data
Aug. 28, 2002 (JP) 2002-249201

(51) Int. Cl. G06F 1/20; F28F 7/00

(52) U.S. Cl. 361/687; 361/683; 361/699; 165/80.3

(57) ABSTRACT

A heat receiving portion is thermally connected to a semiconductor package provided in a main unit. A display unit has a display panel and a display housing and is supported on the main unit. A heat radiating portion having a circulation channel is provided inside the display housing. A circulating path is arranged to extend between the main unit and the display unit in order to circulate a refrigerant between the heat receiving portion and the circulation channel in the heat radiating portion. The display housing is provided with a light transmitting portion formed of a transparent member in association with the heat radiating portion. A color changing layer is provided inside the display housing and changes its own color or color tone upon receiving heat radiated by the heat radiating portion.

### CROSS-REFERENCE TO RELATED APPLICATIONS

This application is based upon and claims the benefit of priority from the prior Japanese Patent Application No. 2002-249201, filed Aug. 28, 2002, the entire contents of which are incorporated herein by reference.

### BACKGROUND OF THE INVENTION

1. Field of the Invention

The present invention relates to an electronic apparatus comprising a heat generating element, e.g. a semiconductor package.

2. Description of the Related Art

There have been smaller functional differences among various types of electronic apparatuses such as portable computers. Users have paid more attention to outward design as well as functions in selecting an electronic apparatus. Thus, users have recently been more interested in the appearance and design of electronic apparatuses.

Among such electronic apparatuses are reversible temperature-sensing color changing cellular telephones published in Jpn. Pat. Appln. KOKAI Publication No. 2002-64603. One of the cellular telephones described in this publication is provided with a reversible temperature-sensing color changing layer on at least a part of its outer surface. Another cellular telephone described in this publication has a reversible thermal color changing pigment dispersed in at least a part of a plastic member constituting an outer case. These cellular telephones appear finer by thermally changing the color of their own outer surface.

With the former of these cellular telephones which is provided with the reversible temperature-sensing color changing layer on its outer surface, the user can directly touch the reversible temperature-sensing color changing layer. Accordingly, as this cellular telephone is repeatedly used, the reversible temperature-sensing color changing layer may be released or have its performance degraded. On the other hand, with the latter cellular telephone that has the reversible thermal color changing pigment dispersed in the plastic member, it is necessary to provide, for example, a facility that disperses the reversible thermal color changing pigment in plastics in order to manufacture this cellular telephone. Consequently, this cellular telephone requires high manufacturing costs.

### BRIEF SUMMARY OF THE INVENTION

Embodiments of the present invention are provided an electronic apparatus with color changing layer inside the display housing.

According to an embodiment of the present invention, an electronic apparatus has an electronic comprising: a main unit having a heat generating element; a heat receiving portion provided in the main unit and thermally connected to the heat generating element; a display unit supported to the main unit and having a display housing and a display panel provided to the display housing; a heat radiating portion provided in the display housing, to radiate heat generated by heat generating element; and a circulation path to circulate a liquid coolant between the heat receiving portion and the heat radiating portion; a light transmitting portion provided in a part of an area corresponding to the heat radiating portion of the display housing; and a color changing layer provided in a part of an area located inside the display housing and corresponding to the heat radiating portion, the color changing layer changing its own color or color tone at a temperature of the heat radiating portion.

Additional features and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the embodiments given below, serve to explain the principles of the invention.

FIG. 1 is a perspective view of a portable computer according to a first embodiment of the present invention as viewed from its front;

FIG. 2 is an exploded perspective view of the portable computer according to the first embodiment of the present invention, showing the positional relationship of a cooling unit;

FIG. 3 is a sectional view of the portable computer according to the first embodiment of the present invention, showing the positional relationship of a cooling unit;

FIG. 4 is a sectional view showing that a heat receiving portion integrated with a pump is fixed to a printed circuit board via a holding member according to first embodiment of the present invention;

FIG. 5 is a sectional view of a heat radiating portion according to the first embodiment of the present invention;

FIG. 6 is a perspective view of the portable computer according to the first embodiment of the present invention as viewed from its rear;

FIG. 7 is a sectional view of a display unit according to the first embodiment of the present invention;

FIG. 8 is a perspective view of a portable computer according to a second embodiment of the present invention as viewed from its rear;

FIG. 9 is a sectional view of a display unit according to the second embodiment of the present invention;

FIG. 10 is a perspective view of a portable computer according to a third embodiment of the present invention as viewed from its rear;

FIG. 11 is a sectional view of a display unit according to the third embodiment of the present invention;

FIG. 12 is a perspective view of a portable computer according to a fourth embodiment of the present invention as viewed from its rear;

FIG. 13 is a sectional view of a display unit according to the fourth embodiment of the present invention;

FIG. 14 is a perspective view of a portable computer according to a fifth embodiment of the present invention as viewed from its rear;

FIG. 15 is a sectional view of a display unit according to the fifth embodiment of the present invention;

FIG. 16 is a perspective view of a part of a portable computer according to a sixth embodiment of the present invention as viewed from its front;

FIG. 17 is a sectional view of a part of a housing which is close to a palm rest according to the sixth embodiment of the present invention;

FIG. 18 is a perspective view of a part of a portable computer according to a seventh embodiment of the present invention as viewed from its front; and

FIG. 19 is a sectional view of a housing and a keyboard according to the seventh embodiment of the present invention.

### DETAILED DESCRIPTION OF THE INVENTION

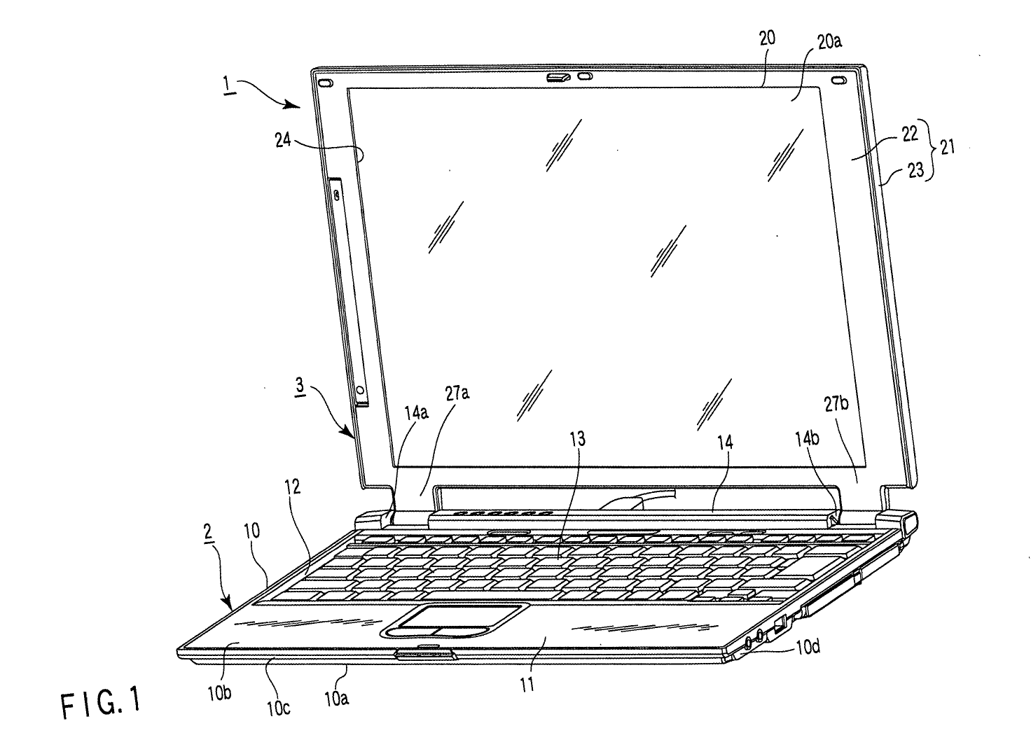

A first embodiment of the present invention will be described below with reference to FIGS. 1 to 7.

FIG. 1 discloses a portable computer 1 as an electronic apparatus. The portable computer 1 comprises a main unit 2 and a display unit 3.

As shown in FIG. 1, the main unit 2 has a flat box-shaped housing 10. The housing 10 comprises a bottom wall 10a, a top wall 10b, a front wall 10c, a right and left side walls 10d, a rear wall 10e. The top wall 10b has a palm rest 11 and a keyboard mounting portion 12. The keyboard mounting portion 12 is located behind the palm rest 11. A keyboard 13 is mounted on the keyboard mounting portion 12.

The top wall 10b has a display supporting portion 14 behind the keyboard mounting portion 12. The display supporting portion 14 extends upward from a rear end of the top wall 10b and in a width direction of the housing 10. The display supporting portion 14 has a pair of dimples 14a and 14b. The dimples 14a and 14b are spaced from each other in the width direction of the housing 10.

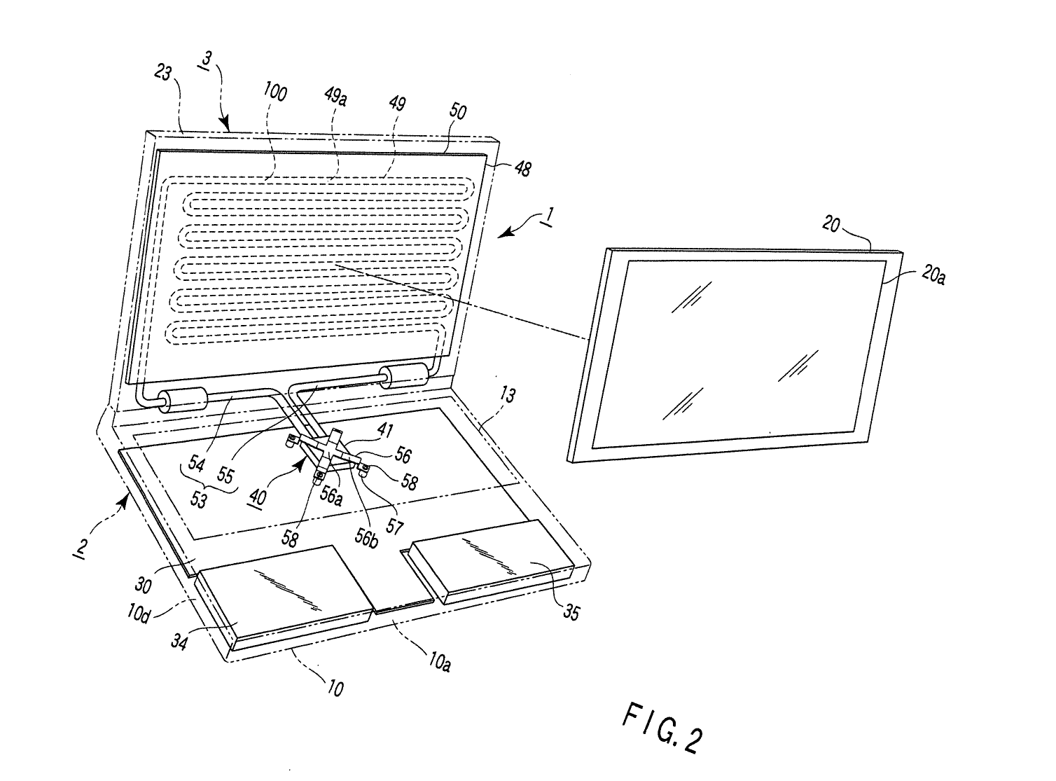

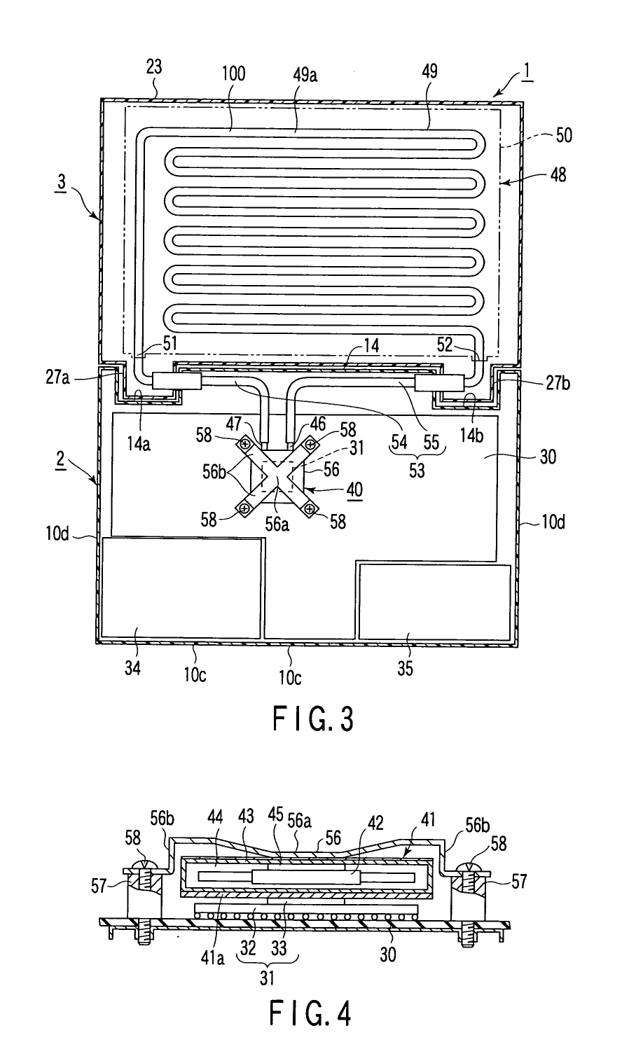

As shown in FIGS. 2 and 3, the display unit 3 comprises a liquid crystal display panel 20 as a display panel and a flat box-shaped display housing 21 that accommodates the liquid crystal display panel 20. The liquid crystal display panel 20 has a screen 20a that displays an image on its front surface.

The display housing 21 comprises a mask 22 and a cover 23 (see FIG. 7). Specifically, the mask 22 has a front wall 22a having an opening 24 and four side walls 22b. The cover 23 has a rear wall 23a and four side walls 23b. The mask 22 and the cover 23 are combined together so that the side wall 22b and the side wall 23a are directed inward and so that the front wall 22a and the rear wall 23a are arranged opposite each other. The mask 22 and the cover 23 form the display housing 21. The liquid crystal display panel 20 is accommodated in the display housing 21 so that its periphery is held by a rubber frame 26. The screen 20a of the liquid crystal display panel 20 is exposed from the display housing 21 through the opening 24.

The display housing 21 has a pair of leg portions 27a and 27b projecting from one end of it. The leg portions 27a and 27b each constitute a hollow portion and are spaced from each other in the width direction of the display housing 21. The leg portions 27a and 27b are inserted into the dimples 14a and 14b, respectively, in the display supporting portion 14. The leg portions 27a and 27b are connected to the housing 10 via a hinge device not shown in the drawings.

Thus, the display unit 3 is supported to the main unit 2 so as to move rotatively between a closed position in which it is brought down to cover the keyboard 13 from above and an opened position in which it is brought up to exposed the keyboard 13 and the screen 20a.

As shown in FIGS. 2 and 3, the housing 10 accommodates a printed circuit board 30, a hard disk drive device 34, and a battery pack 35. The printed circuit board 30, the hard disk drive device 34, and the battery pack 35 are arranged on the inner surface of the bottom wall 10a of the housing 10.

As shown in FIG. 4, a semiconductor package 31 as a heat generating element is mounted on the top surface of the printed circuit board 30. The semiconductor package 31 constitutes a microprocessor acting as a core of the portable computer 1 and is located behind the printed circuit board 30. The semiconductor package 31 has a base substrate 32 and an IC chip 33 arranged in a central portion of the top surface of the base substrate 32.

The IC chip 33 generates a very large amount of heat because of its constantly increased processing speed and its constantly increased number of functions. Consequently, the IC chip 33 must be cooled in order to operate stably. Thus, a liquid-cooling-type cooling unit 40 is mounted on the portable computer 1 to cool the semiconductor package 31.

As shown FIGS. 2 to 5, the cooling unit 40 comprises a rotary pump 41 integrated with a heat receiving portion 41a, a heat radiating portion 48, and a circulation path 53. As shown in FIG. 4, the heat receiving portion 41a is composed of a metal plate larger than the base substrate 32 of the semiconductor package 31 and covers the IC chip 33 from above. The IC chip 33 is thermally connected to a central portion of the bottom surface of the heat receiving portion 41a via conductive grease not shown in the drawings.

The pump 41 comprises an impeller 42 and a pump housing 43. The impeller 42 is supported on the pump housing 43 via a flat motor 45. The flat motor 45 rotates the impeller 42, for example, when the portable computer 1 is powered on or when the temperature of the semiconductor package 31 reaches a predetermined temperature. The pump housing 43 has a pump chamber 44 and a refrigerant inlet 46 and a refrigerant outlet 47 both connected to the pump chamber 44. The impeller faces the pump chamber 44.

As shown in FIGS. 2 and 3, the heat radiating portion 48 is accommodated inside the display housing 21. In the present embodiment, the heat radiating portion 48 is accommodated between the cover 23 of the display housing 21 and the liquid crystal display panel 20. The heat radiating portion 48 is shaped like a rectangular plate having a size substantially equivalent to that of the liquid crystal display panel 20.

Further, as shown in FIGS. 2, 3, and 5, the heat radiating portion 48 comprises a first heat radiating plate 49 and a second heat radiating portion 50. The first and second heat radiating portions 49 and 50 are composed of a highly conductive metal material and laid on top of each other. The first heat radiating portion 49 has a bulging portion 49a projected from it in a direction opposite to the second heat radiating plate 50. The bulging portion 49a is formed to meander almost all over the surface of the first heat radiating plate. An opening end of the bulging portion 49a is closed by the second heat radiating portion 50. Thus, the bulging portion 49a of the first heat radiating portion 49 constitutes a circulation channel 100 between the first heat radiating plate 49 and the second heat radiating plate 50.

As shown in FIG. 3, the heat radiating portion 48 has a refrigerant inlet 51 and a refrigerant outlet 52. The refrigerant inlet 51 is located at the left end (the left of FIG. 3) of the heat radiating portion 48 to connect to an upstream end of a circulation channel 100. The refrigerant inlet 51 is located adjacent to the left leg portion 27a. The refrigerant outlet 52 is located at the right end (the right of FIG. 3) of the heat radiating portion 48 to connect to a downstream end of the circulation channel 100. The refrigerant outlet 52 is located adjacent to the right leg portion 27b. Thus, the refrigerant inlet 51 and the refrigerant outlet 52 are spaced from each other in the width direction of the display housing 21.

The circulation path 53 circulates a liquid refrigerant between the heat receiving portion 41a and the circulation channel 100 in the heat radiating portion 48. As shown in FIGS. 2 and 3, the circulating path 53 comprises a first line 54 and a second line 55. The first line 54 is extended between the main unit 2 and the display unit 3 to connect the refrigerant outlet 47 of the pump housing 43 to the refrigerant inlet 51 of the heat radiating portion 48. The first line 54 is guided from the interior of the housing 10 through the inside of the display supporting portion 14 and left leg portion 27a to the interior of the display housing 21. The second line 55 is extended between the main unit 2 and the display unit 3 to connect the refrigerant inlet 46 of the pump housing 43 to the refrigerant outlet 52 of the heat radiating portion 48. The second line 55 is guided from the interior of the housing 10 through the inside of the display supporting portion 14 and right leg portion 27b to the interior of the display housing 21.

The pump chamber 44, the refrigerant path 100, and the circulating path 53 are filled with a coolant as a liquid refrigerant. The coolant is, for example, an antifreeze solution consisting of an aqueous solution of ethylene glycol to which a corrosion inhibiter is added as required.

As shown in FIGS. 2 to 4, the pump 41, integrated with the heat receiving portion 41a, is pressed against the semiconductor package 31 via a cross-shaped spring member 56 having four leg portions 56b. That is, a central portion 56a of the spring member 56 is pressed against the pump 41 owing to the elasticity of the leg portion 56b by fixing the leg portions 56b of the spring member 56 to four boss portions 57 on the printed circuit board 30 using screws 58. Accordingly, the heat radiating portion 41a finely contacts and is thermally connected to the IC chip 33 of the semiconductor package 31.

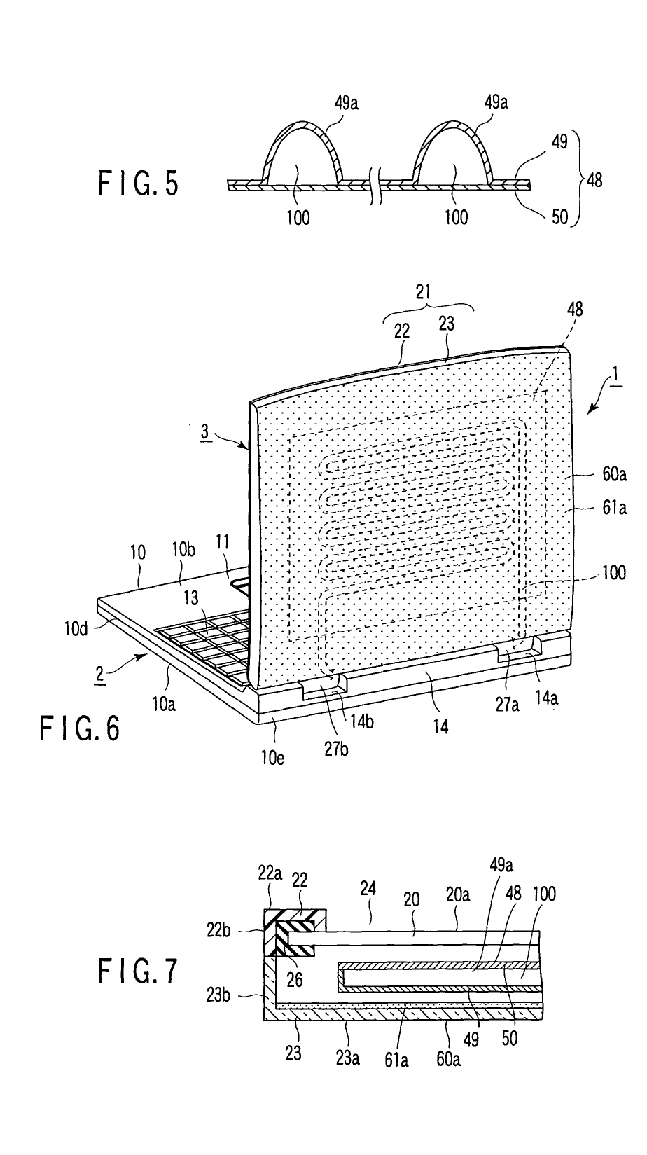

The display housing 21 is provided with a light transmitting portion 60a in association with at least a part of the area corresponding to the heat radiating portion 48, the transmitting portion 60a being formed of a transparent member. In the first embodiment, the cover of the display housing 21 is formed of a transparent member so that the light transmitting portion 60a is composed of almost all the area corresponding to the heat radiating portion 48 (see FIGS. 6 and 7).

Further, a reversible temperature-sensing color changing layer 61a is provided inside the display housing 21 in association with at least a part of the area corresponding to the heat radiating portion 48. The reversible temperature-sensing color changing layer 61a reversibly changes its own color or color tone at a predetermined temperature. In the portable computer 1, the reversible temperature-sensing color changing layer 61a is provided on the inner surface of the rear wall 23a of the cover 23 in association with almost all the area of the heat radiating portion 48, the rear wall 23a constituting the light transmitting portion 60a (see FIGS. 6 and 7). For easy understanding, in FIG. 6, the area in which the reversible temperature-sensing color changing layer 61a is provided is shown with a dotted pattern. The reversible temperature-sensing color changing layer 61a may be provided not only on the inner surface of the rear wall 23a of the cover 23 but also on the inner surfaces of the four side walls 23b.

The cover 23 and the reversible temperature-sensing color changing layer 61a may be formed, for example, in the manner described below.

The cover 23 is molded using a colorless and transparent acrylonitrile-butadiene-styrene copolymer resin (ABS resin). The reversible temperature-sensing color changing layer 61a is formed using a paint obtained by uniformly dispersing a thermal-discoloring-type reversible thermal color changing pigment that has no color at 29° C. or higher and turns black at 27° C. or lower, a thermal-discoloring-type reversible thermal color changing pigment that has no color at 35° C. or higher and turns pink at 33° C. or lower, a blue pigment, a vinyl chloride-vinyl acetate copolymer resin, an oily acrylic resin (45% of solids contents; toluene and ethyl acetate are used as a solvent), methyl isobutyl ketone, and xylene at the following ratio:

30:15:3:30:30:15:15 (1).

This paint is sprayed on the inner surface of the rear wall 23a of the cover 23 so that the reversible temperature-sensing color changing layer 61a has a thickness of 40 μm. Subsequently, the layer 61a is dried and hardened at 40° C. for ten minutes. Thus, the cover 23 and the reversible temperature-sensing color changing layer 61a are formed.

The reversible temperature-sensing color changing layer 61a thus formed turns black at 27° C. or lower, purple between 28 and 34° C., and blue at 35° C. or higher.

The reversible temperature-sensing color changing layer 61a may be formed on the inner surface of the rear wall 23a by forming a reversible temperature-sensing color changing layer on a transparent film consisting of a transparent resin or the like and then sticking this film to the inner surface of the rear wall 23a of the cover 23.

With this configuration, the IC chip 33 of the semiconductor package 31 generates heat while the portable computer 1 is being operated. Heat from the IC chip 33 is transmitted to the pump housing 43 via the heat receiving portion 41a. The pump housing 43 has the pump chamber 44 filled with the coolant. Accordingly, the coolant absorbs much of the heat transmitted to the pump housing 43.

When the impeller 42 is rotated, the coolant in the pump chamber 44 is fed to the heat radiating portion 48 via the first line 54. The coolant is then forcibly circulated between the pump chamber 44 and the circulation channel 100 in the heat radiating portion 48.

Specifically, the coolant heated by heat exchange with the pump chamber 44 is fed to the heat radiating portion 48 via the first line 54. The coolant then flows through the circulation channel 100, bent to meander. During this flow, the heat from the IC chip absorbed by the coolant is diffused to the first and second heat radiating plates 49 and 50. The heat is then radiated from the surfaces of the heat radiating plates 49 and 50.

The coolant cooled while passing through the circulation channel 100 is returned to the pump chamber 44 through the second line 55. The coolant absorbs heat from the IC chip 33 again while flowing through the pump chamber 44. It is then fed to the heat radiating portion 48. This cycle is repeated to release the heat from the IC chip 33 to the exterior of the portable computer 1 through the heat radiating portion 48 in the display housing 21.

The reversible temperature-sensing color changing layer 61a is black at room temperature. When heat is radiated from the surfaces of the heat radiating plates 45 and 50 of the heat radiating portion 48, this radiated heat heats the reversible temperature-sensing color changing layer 61a. The reversible temperature-sensing color changing layer 61a turns purple at 28° C. or higher. Furthermore, it turns blue at 35° C. or higher. In this regard, the temperature of the reversible temperature-sensing color changing layer 61a is balanced at a certain point and does not increase far above 35° C.

Further, when the heat stops being radiated from the surfaces of the heat radiating plates 49 and 50, the reversible temperature-sensing color changing layer 61a is cooled to return to the room temperature. The reversible temperature-sensing color changing layer 61a turns purple at 34° C. or lower. Furthermore, the reversible temperature-sensing color changing layer 61a turns black at 27° C. or lower. These changes in the color of the reversible temperature-sensing color changing layer 61a are seen from the exterior of the portable computer 1 through the light transmitting portion 60a, i.e. the cover 23, composed of the transparent member.

As described above, according to the portable computer 1, the color or color tone of the reversible temperature-sensing color changing layer 61a is varied owing to changes in the temperature of the inside of the display housing 1 caused by heat radiated by the heat radiating portion 48. These changes in the color or color tone of the reversible temperature-sensing color changing layer 61a are externally seen through the light transmitting portion 60a of the display housing 21. Specifically, according to the portable computer 1, after the computer 1 has been simply activated, the appearance of the display housing 21 is varied during operation without the need for the user to perform any special operations. This provides an attractive and well-designed portable computer 1.

Furthermore, according to the portable computer 1, the reversible temperature-sensing color changing layer 61a is provided inside the display housing 21. Consequently, the user does not directly touch the reversible temperature-sensing color changing layer 61a when using or carrying the portable computer 1. This suppresses degradations such as the release of the reversible temperature-sensing color changing layer 61a and the degradation of performance. Further, the computer maintains a fine appearance.

Moreover, in the portable computer 1, the reversible temperature-sensing color changing layer 61a is provided on the housing (the inner surface of the rear wall 23a of the cover 23) by spraying a paint or sticking a film on which the reversible temperature-sensing color changing layer 61a is formed. This eliminates the need for a cumbersome operation of dispersing a reversible thermal color changing pigment in a plastic member when providing the reversible temperature-sensing color changing layer 61a on the housing 10. It is thus possible to reduce manufacturing costs.

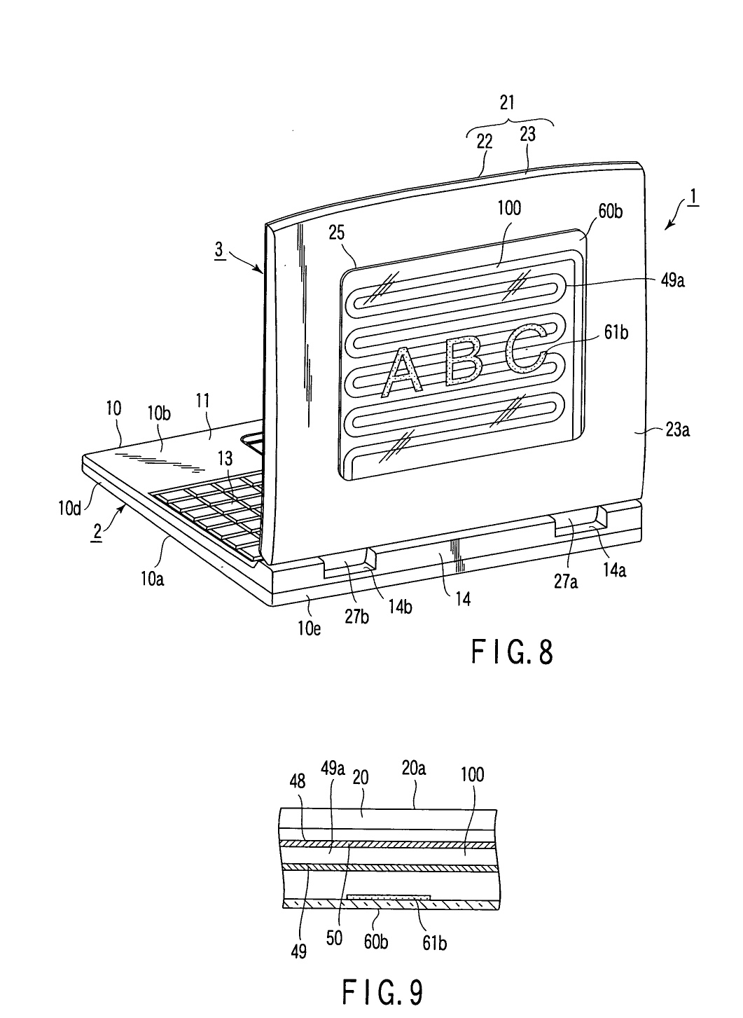

The present invention is not limited to the first embodiment. A second embodiment of the present invention will be described below with reference to FIGS. 8 and 9.

The second embodiment is different from the first embodiment in the area in which the light transmitting portion is provided and in the area in which the reversible temperature-sensing color changing layer is provided. The other basic arrangements of the portable computer 1 are similar to those of the first embodiment. Thus, in the second embodiment, the same components as those of the first embodiment are denoted by the same reference numerals. Their description is omitted.

The cover 23 of the display housing 21 is formed of, for example, a colored opaque resin. Further, an opening 25 is formed in the rear wall 23a of the cover 23 in association with a part of the area corresponding to the heat radiating portion 48 so that the bulging portion 49a on the first heat radiating plate 49 is exposed from the opening 25. A panel-like light transmitting portion 60b formed of a transparent member, e.g., a colorless transparent resin or glass, is fitted into the opening 25.

A reversible temperature-sensing color changing layer 61b is not provided all over the surface of the light transmitting portion 60b but on a part of it so as to show characters or a pattern. In the portable computer 1, the reversible temperature-sensing color changing layer 61b is provided to show, for example, the characters “ABC”. For easy understanding, in FIG. 8, the area in which the reversible temperature-sensing color changing layer 61b is provided is shown with a dotted pattern.

The reversible temperature-sensing color changing layer 61b can be formed by, for example, silk screen printing or the like to print directly and then dry the inner surface of the light transmitting portion 60b or forming a reversible temperature-sensing color changing layer all over the surface of a transparent film consisting of a transparent resin or the like, cutting the film into the form of desired characters, and sticking the characters obtained onto the inner surface of the light transmitting portion 60b.

The color or color tone of the portable computer 1 is varied owing to changes in the temperature of the inside of the display housing 1 caused by heat radiated by the heat radiating portion 48. These changes in the color or color tone are externally seen through the light transmitting portion 60b, formed of the transparent member. This provides a fine-appearing and well-designed portable computer 1.

Further, a member may be provided between the reversible temperature-sensing color changing layer 61b and the heat radiating portion 48 to conceal the heat radiating portion 48 from the exterior.

Furthermore, the characters can be made to appear at a predetermined temperature by selecting as a paint forming the reversible temperature-sensing color changing layer 61b, for example, a reversible temperature-sensing color changing paint that has no color at a temperature lower than the predetermined one and assumes a certain color at this predetermined temperature or higher.

Moreover, the characters can be made to disappear at a predetermined temperature by selecting as a paint forming the reversible temperature-sensing color changing layer 61b, for example, a reversible temperature-sensing color changing paint that assumes a certain color at a temperature lower than the predetermined one and become colorless at this predetermined temperature or higher.

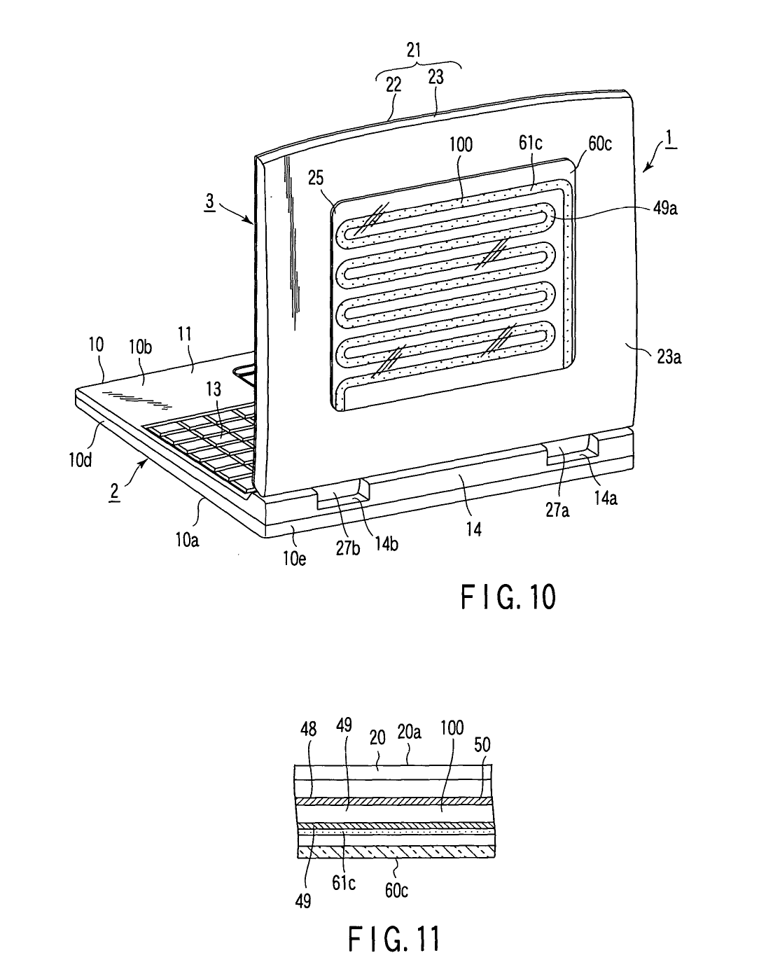

Now, a third embodiment of the present invention will be described with reference to FIGS. 10 and 11.

The third embodiment differs from the first embodiment, described above, in the area in which the light transmitting portion is provided and in the area in which the reversible temperature-sensing color changing layer is provided. The other basic arrangements of the portable computer 1 are similar to those of the first embodiment. Thus, in the third embodiment, the same components as those of the first embodiment are denoted by the same reference numerals. Their description is omitted.

The cover 23 of the display housing 21 is formed of, for example, a colored opaque resin. Further, the opening 25 is formed in the rear wall 23a of the cover 23 in association with a part of the area corresponding to the heat radiating portion 48 so that the bulging portion 49a on the first heat radiating plate 49 is exposed from the opening 25. A panel-like light transmitting portion 60c formed of a transparent member, e.g. a colorless transparent resin or glass is fitted into the opening 25.

Further, as shown in FIG. 11, a reversible temperature-sensing color changing layer 61c is provided on the outer surface of the circulation channel 100 formed between the bulging portion 49a of the first heat radiating plate 49 and the second heat radiating plate 50, i.e., on the outer surface of the bulging portion 49a. For easy understanding, in FIG. 10, the area in which the reversible temperature-sensing color changing layer 61c is provided is shown with a dotted pattern.

The color or color tone of the portable computer 1 is varied owing to changes in the temperature of the outer surface of the circulation channel 100 caused by heat radiated by the heat radiating portion 48. These changes in the color or color tone are externally seen through the light transmitting portion 60c formed of the transparent member. This provides an attractive and well-designed portable computer 1.

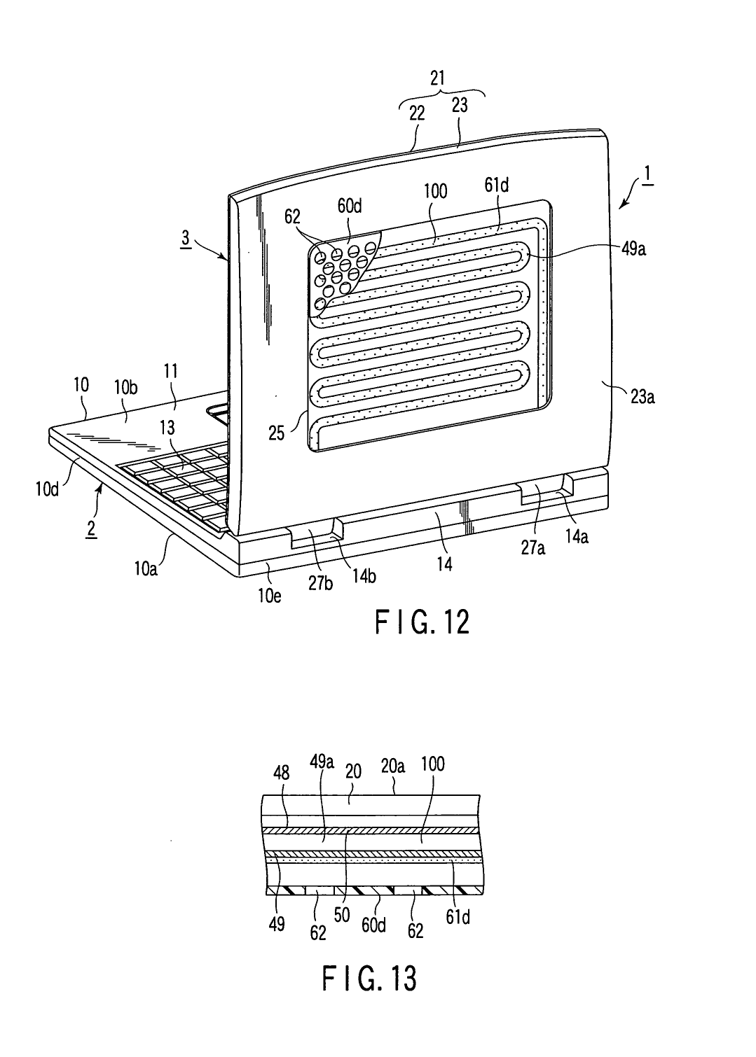

FIGS. 12 and 13 disclose a fourth embodiment of the present invention.

The fourth embodiment differs from the first embodiment, described above, in the form of the light transmitting portion and in the area in which the reversible temperature-sensing color changing layer is provided. Thus, in the fourth embodiment, the same components as those of the first embodiment are denoted by the same reference numerals. Their description is omitted.

The cover 23 of the display housing 21 is formed of, for example, a colored opaque resin. Further, the opening 25 is formed in the rear wall 23a of the cover 23 in association with a part of the area corresponding to the heat radiating portion 48 so that the bulging portion 49a on the first heat radiating plate 49 is exposed from the opening 25. A light transmitting portion 60d is fitted into the opening 25. The light transmitting portion 60d is composed of a panel formed of a colored opaque resin or the like and in which a plurality of hole portions 62 are formed. The hole portions 62 are each sized so that the user's fingers do not slip into the hole portions 62. The opening 25 in the rear wall 23a of the cover 23 may be omitted with the hole portions 62 formed directly in the rear wall 23.

Further, as shown in FIG. 13, the reversible temperature-sensing color changing layer 61d is provided on the outer surface of the circulation channel 100 formed between the bulging portion 49a of the first heat radiating plate 49 and the second heat radiating plate 50, i.e., on the outer surface of the bulging portion 49a. For easy understanding, in FIG. 12, the area in which the reversible temperature-sensing color changing layer 61c is provided is shown with a dotted pattern.

The color or color tone of the portable computer 1 is varied owing to changes in the temperature of the outer surface of the circulation channel 100 caused by heat radiated by the heat radiating portion 48. These changes in the color or color tone are externally seen through the hole portions 62 in the light transmitting portion 60d formed. This provides an attractive and well-designed portable computer 1.

Further, in the portable computer 1, the hole portions 62 are each sized so that the user's fingers do not slip into the hole portions 62. Accordingly, the user does not directly touch the reversible temperature-sensing color changing layer 61d. This suppresses the degradation of the reversible temperature-sensing color changing layer 61d to keep the computer 1 appearing attractive.

Furthermore, according to the portable computer 1, the plurality of hole portions 62 are located opposite the heat radiating portion 48. Consequently, heat radiated from the surface of the heat radiating portion 48 can be efficiently radiated to the exterior of the display housing 1 through the hole portions 62. This hinders heat from remaining between the heat radiating plate and the rear wall 23a.

In the fourth embodiment, the light transmitting portion 60d is composed of the panel formed of a colored opaque resin or the like and in which the plurality of hole portions 62 are formed. The light transmitting portion 60d may be composed of a panel formed of a colorless transparent resin or the like and in which the plurality of hole portions 62 are formed. Alternatively, the light transmitting portion 60d may be composed of a panel formed of a colored transparent resin or the like and in which the plurality of hole portions 62 are formed. In this case, the color observed through the holes is that of the reversible temperature-sensing color changing layer 61d, whereas the color observed in the areas other than the hole portions 62 is a mixture of the colors of the light transmitting portion 60d and the reversible temperature-sensing color changing layer 61d.

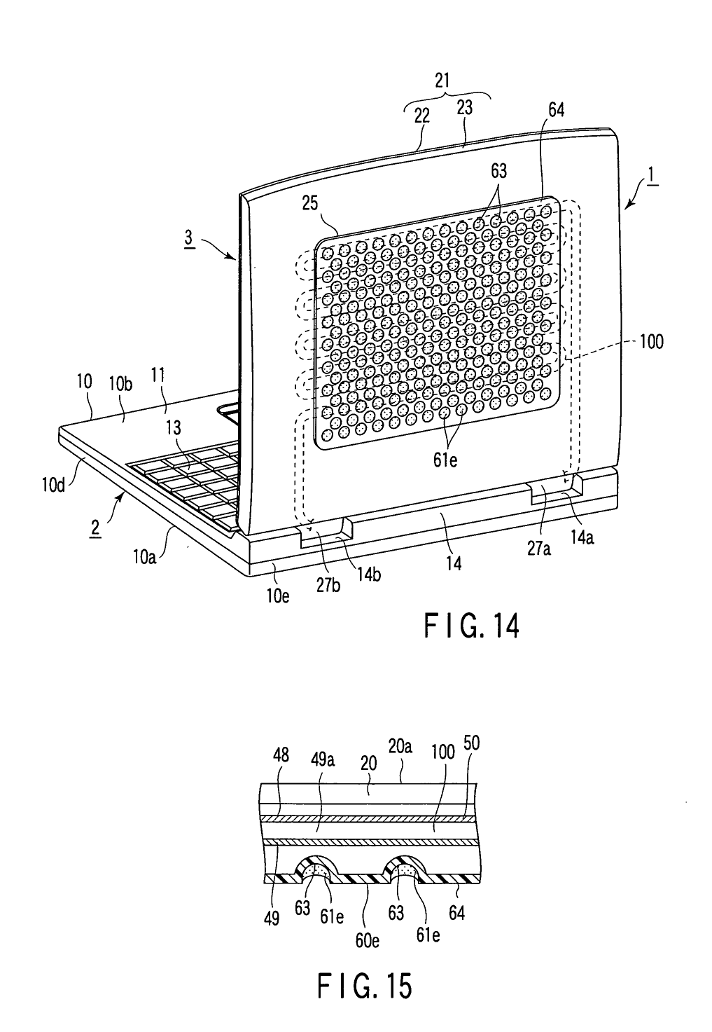

Now, a fifth embodiment of the present invention will be described with reference to FIGS. 14 and 15.

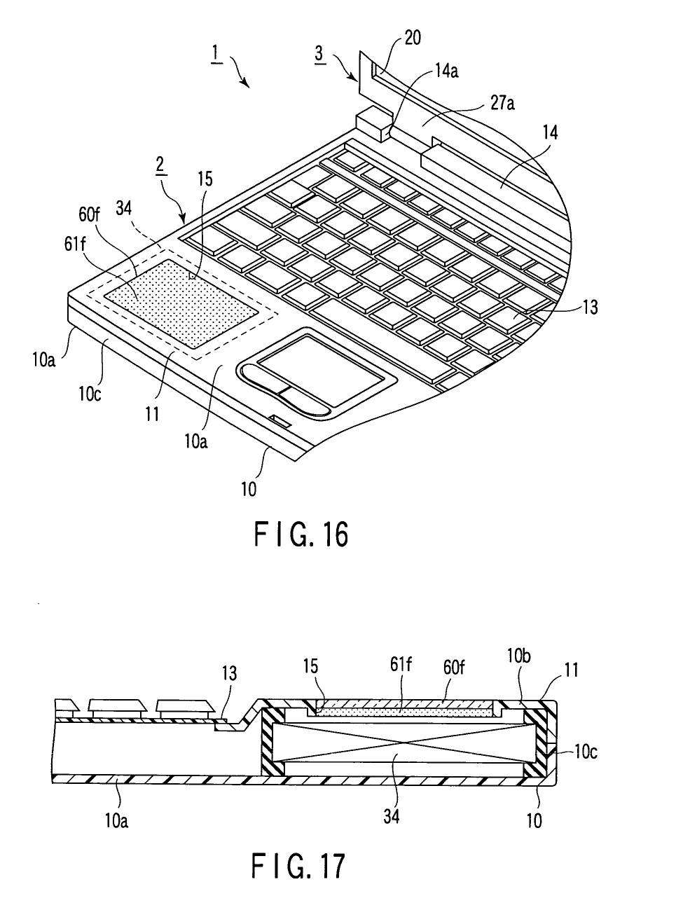

The cover 23 of the display housing 21 is formed of, for example, a colored opaque resin. Further, the opening 25 is formed in the rear wall 23a of the cover 23 in association with a part of the area corresponding to the heat radiating portion 48 so that the bulging portion 49a on the first heat radiating plate 49 is exposed from the opening 25. A panel 64 having a plurality of dimples 63 formed in its outer surface is fitted in the opening 25. The panel 64 is formed of, for example, a colored opaque resin. The pluralities of dimples 63 are each sized so that the user's fingers do not slip into the dimples 63. The opening 25 in the rear wall 23a of the cover 23 may be omitted with the dimples 63 formed directly in the rear wall 23. The other arrangements are the same as those of the first embodiment, described above. Thus, duplicate description is omitted by using, in FIGS. 15 and 16, the same reference numerals as those in the first embodiment.

Further, as shown in FIGS. 14 and 15, a reversible temperature-sensing color changing layer 61e is provided in each of the dimples 63. For easy understanding, in FIG. 14, the area in which the reversible temperature-sensing color changing layer 61e is provided is shown with a dotted pattern.

The color or color tone of the dimples 63 is varied owing to changes in the temperature of the display housing 21 caused by heat radiated by the heat radiating portion 48. This provides a fine-appearing and well-designed portable computer 1.

Further, in the portable computer 1, the dimples 63 are each sized so that the user's fingers do not slip into the dimples 63. Accordingly, the user does not directly touch the reversible temperature-sensing color changing layer 613. This suppresses the degradation of the reversible temperature-sensing color changing layer 61d to keep the computer 1 appearing attractive.

Furthermore, according to the portable computer 1, the plurality of dimples 63 are formed in the panel 64, constituting a part of the cover 23 of the display housing 21. This makes it possible to increase the surface area of the cover 23. Thus, with the portable computer 1, heat radiated from the surface of the heat radiating portion 48 can be efficiently radiated to the exterior of the display housing 21. This hinders heat from remaining between the heat radiating plate and the rear wall 23a.

Now, a sixth embodiment of the present invention will be described with reference to FIGS. 16 and 17.

In the portable computer 1, for example, the hard disk drive device 34 is used as a heat generating element. Further, as shown in FIGS. 16 and 17, an opening 15 a size smaller than the hard disk drive device 34 is formed in the top wall 10b of the housing 10 in association with the hard disk drive device 34. A panel-like light transmitting portion 60f formed of a transparent member, e.g. a colorless transparent resin or glass, is fitted into the opening 15.

The reversible temperature-sensing color changing layer 61f is provided on the inside of the housing 10, e.g. on the inner surface of the light transmitting portion 60f, constituting a part of the housing 10. For easy understanding, in FIG. 16, the area in which the reversible temperature-sensing color changing layer 61f is provided is shown with a dotted pattern. The other arrangements are the same as those of the first embodiment, described above. Accordingly, duplicate description is omitted by using, in FIGS. 16 and 17, the same reference numerals as those in the first embodiment.

In the portable computer 1, the color or color tone of the reversible temperature-sensing color changing layer 61f is varied owing to changes in temperature caused by heat radiated by the hard disk drive device 34. Further, changes in the color of the reversible temperature-sensing color changing layer 61f are externally seen through the light transmitting portion 60f, constituting the transparent member.

The housing 10 appears to change partly its own color or color tone. This provides an attractive and well-designed portable computer 1.

In this embodiment, the light transmitting portion 60f and the reversible temperature-sensing color changing layer 61f are provided in association with the hard disk drive device 34. However, the light transmitting portion 60f and the reversible temperature-sensing color changing layer 61f may be provided in association with another heat generating element such as a battery or a semiconductor package.

Further, in the portable computer 1, the liquid-cooling-type cooling unit 40, shown in the first embodiment, may be replaced with, for example, an air-cooling-type cooling unit having a heat receiving portion, a heat pipe, a heat exchanging portion, and an electric fan.

Furthermore, if the heat radiating portion of the cooling unit is provided in the housing 10, the light transmitting portion 60f and the reversible temperature-sensing color changing layer 61f may be provided in association with the heat radiating portion of the cooling unit.

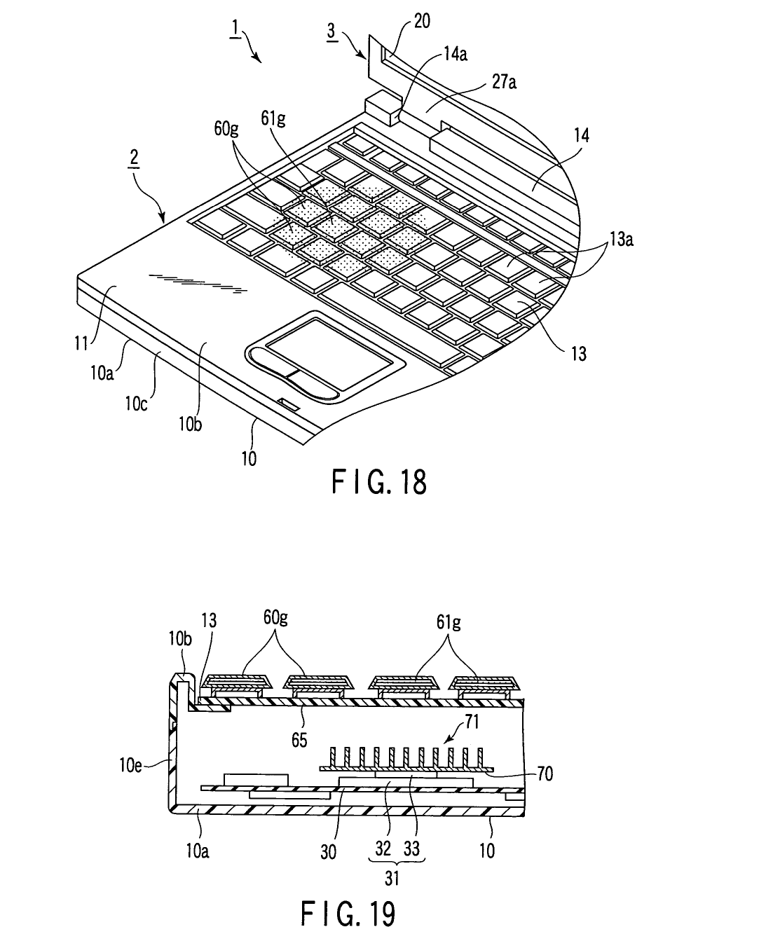

FIGS. 18 and 19 disclose a seventh embodiment of the present invention.

In the portable computer 1, the liquid-cooling-type cooling unit 40, shown in the first embodiment, is replaced with, for example, an air-cooling-type cooling unit 71 having a heat receiving portion 70. As shown in FIG. 19, the heat receiving portion 70 is composed of a metal plate larger than the base substrate 32 of the semiconductor package 31. The heat receiving portion 70 covers the IC chip 33 from above. The heat receiving portion 70 is thermally connected to a heat sink via a heat pump not shown in the drawings. The heat sink is disposed away from the heat receiving portion 70. Cooling winds are blown against the heat sink via the electric fan.

Further, in the portable computer 1, the keyboard 13 is located above the heat receiving portion 70. The keyboard 13 has a plurality of key tops 13a and a support plate 65 that supports the key tops 13a. Those of the key tops 13a which are located in an area immediately above the heat receiving portion 70 are formed of a colorless transparent resin material. These key tops 13a formed of the colorless transparent resin material constitute a light transmitting portion 60g. The reversible temperature-sensing color changing layer 61g is provided all over the inner surfaces of the transparent key tops. FIG. 18 schematically shows, by a dotted pattern, that the color of the reversible temperature-sensing color changing layer 61g has been changed. The other arrangements are the same as those of the first embodiment, described above. Accordingly, duplicate description is omitted by using, in FIGS. 18 and 19, the same reference numerals as those in the first embodiment.

With this configuration, when the semiconductor package 31 is heated, heat from the semiconductor package 31 is transmitted to the heat receiving portion 70. When the heat from the semiconductor package 31 is transmitted to the heat transmitting section 70, part of the heat is radiated from the surface of the heat receiving portion 70. The radiated heat heats and changes the color of the reversible temperature-sensing color changing layer 61g on the key tops 13a located in the area corresponding to the semiconductor package 31 (see FIG. 18). Since the key tops 13a having the reversible temperature-sensing color changing layer 61g are formed of the transparent member, the density of the color or color tone of the reversible temperature-sensing color changing layer 61g can be seen from outside the keyboard 13. This provides an attractive and well-designed portable computer 1.

The reversible temperature-sensing color changing layer 61g may be provided on the outer surfaces of the key tops 13a located opposite the heat receiving portion 70. This makes it possible to change the color or color tone of the key tops 13a located in the area corresponding to the semiconductor package 31.

Further, in this embodiment, the reversible temperature-sensing color changing layer 61g on the key tops 13a is provided in association with the heat receiving portion 70. However, if the battery or hard disk drive device, which generates heat, is arranged below the keyboard 13, the reversible temperature-sensing color changing layer 61g on the key tops 13a may be provided in association with the battery or hard disk drive device.

In the first, second, third, sixth, and seventh embodiments, the light transmitting portions 60a, 60b, 60c, 60f, and 60g are each composed of a colorless transparent member. However, the light transmitting portions 60a, 60b, 60c, 60f, and 60g may each be composed of a colored transparent member. In this case, the externally observed color is a mixture of the colors of the light transmitting portion 60a, 60b, 60c, 60f, or 60g and reversible temperature-sensing color changing layer 61a, 61b, 61c, 61f, or 61g.

Further, in the first embodiment, three colors are made to appear by using two types of reversible temperature-sensing color changing paints and one type of pigment and changing their colors in the two temperature zones, i.e. between 27 and 28° C. and between 34 and 35° C. However, it is possible to use any number of types of reversible temperature-sensing color changing paints and pigments. Furthermore, the paint forming the reversible temperature-sensing color changing layers 61a to 61g is not limited to the paint shown in the first embodiment. A wide variety of reversible temperature-sensing color changing paints can be used.

The electronic apparatus according to the present invention is not limited to a portable computer. The present invention is applicable to various electronic apparatuses comprising a heat generating element.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic comprising:
a main unit having a heat generating element;
a heat receiving portion provided in the main unit and thermally connected to the heat generating element;
a display unit supported to the main unit and having a display housing and a display panel provided to the display housing;
a heat radiating portion provided in the display housing, to radiate heat generated by heat generating element; and
a circulation path to circulate a liquid coolant between the heat receiving portion and the heat radiating portion;
a light transmitting portion provided in a part of an area corresponding to the heat radiating portion of the display housing; and
a color changing layer provided in a part of an area located inside the display housing and corresponding to the heat radiating portion, the color changing layer changing its own color or color tone at a temperature of the heat radiating portion.

2. An electronic apparatus according to claim 1, wherein the display housing comprises a front wall having an opening which the display panel is exposed and a rear wall located opposite the front wall, and the light transmitting portion is provided on the rear wall.

3. An electronic apparatus according to claim 1, wherein the color changing layer is provided on an inner surface of the light transmitting portion.

4. An electronic apparatus according to claim 1, wherein the heat radiating portion has a circulation channel, the color changing layer is provided on the outer surface of the circulation channel.

5. An electronic apparatus according to claim 1, wherein the light transmitting portion is formed of a transparent member.

6. An electronic apparatus according to claim 1, wherein the light transmitting portion has a plurality of hole portions.

7. An electronic apparatus comprising:
a heat generating element;
a housing that accommodates heat generating element;
a light transmitting portion provided in a part of an area corresponding to the heat generating element in the housing; and
a color changing layer provided in a part of an area located inside the housing and corresponding to the heat generating element, the color changing layer changing its own color or color tone at a predetermined temperature.

8. An electronic apparatus according to claim 7, wherein the housing comprises a keyboard having a plurality of key tops, and the key tops have the light transmitting portion.

9. An electronic apparatus according to claim 7, wherein the housing has a palm rest, and the light transmitting portion is provided in the palm rest.

10. An electronic apparatus according to claim 7, wherein the light transmitting portion is formed of a transparent member.

11. An electronic apparatus according to claim 7, wherein the light transmitting portion has a plurality of hole portions.

12. An electronic comprising:
a main unit having a heat generating element;
a heat receiving portion provided in the main unit and thermally connected to the heat generating element;
a display unit supported on the main unit and having a display housing and a display panel provided in the display housing;
a heat radiating portion provided inside the display housing and having a circulation channel;
a circulation path arranged to extend between the main unit and the display unit in order to circulate a refrigerant between the hear receiving portion and the circulation channel in the heat radiating portion;
a plurality of dimples dimplesprovided to an outer surface of the display housing and at positions corresponding to the heat radiating portion; and
a color changing layer provided in the dimples and changing its own color or color tone at a predetermined temperature of the heat radiating portion.

13. An electronic apparatus according to claim 12, wherein the display housing comprises a front wall having an opening which the display panel is exposed and a rear wall located opposite the front wall, and the dimples are provided to the rear wall.
